(19) United States
(12) Patent Application Publication
(10) Pub. No.: US 2026/0260270 A1
(43) Pub. Date: Sep. 3, 2026

(54) SYSTEMS AND METHODS FOR ADMINISTERING CHARITABLE PLEDGE AND FUNDING ARRANGEMENTS USING LIFE INSURANCE POLICIES, TRUST STRUCTURES, AND COMPUTER-IMPLEMENTED PLATFORMS

(71) Applicants: Robert Jones, Dallas, TX (US); Martin Mungwa, New Milford, NJ (US)

(72) Inventors: Robert Jones, Dallas, TX (US); Martin Mungwa, New Milford, NJ (US)

(21) Appl. No.: 19/535,726

(22) Filed: Feb. 10, 2026

Related U.S. Application Data
(60) Provisional application No. 63/759,721, filed on Feb. 18, 2025.

(51) Int. Cl. G06Q 30/0279; G06Q 40/08

(52) U.S. Cl. CPC G06Q 30/0279; G06Q 40/08

(57) ABSTRACT

A system and method for administering charitable contribution programs using life insurance policies and trust structures. A computing platform records donor pledges, administers policy-based charitable arrangements, and determines values associated with pledged policy benefits. The system may include valuation modules configured to determine present values of pledged benefits using actuarial data and financial parameters, trust administration modules configured to manage policy-based contributions, and user interfaces for donors, charitable organizations, and administrators. The platform may further include data repositories, processing engines, and communication interfaces configured to track pledges, manage policy-linked funding arrangements, and generate reports associated with charitable contributions. The system enables structured charitable funding using insurance policies, trust mechanisms, and digital processing components configured to administer and monitor such arrangements.

### CROSS REFERENCE TO RELATED APPLICATIONS

This application claims priority to U.S. Provisional Patent Application No. 63/759,721, filed Feb. 18, 2025, entitled “System and Method for Tax Deductible Charitable Contributions Using Life Insurance Policies and Trusts,” the entire contents of which are incorporated herein by reference.

### FIELD OF THE INVENTION

The present invention relates generally to computer-implemented financial administration systems, charitable giving platforms, and insurance-based funding mechanisms, and more particularly to systems and methods for facilitating structured charitable pledge and funding arrangements using life insurance policies, trust structures, and digital processing platforms configured to administer, track, model, and manage such arrangements. The invention further relates to computerized systems for administering charitable pledges, policy-based collateral and funding arrangements, trust-managed charitable structures, and associated valuation, optimization, tracking, reporting, and coordination processes across multiple participants and computing environments.

### BACKGROUND OF THE INVENTION

Individuals, businesses, and nonprofit organizations often seek structured mechanisms for supporting charitable initiatives while coordinating long-term financial planning objectives. Traditional charitable giving methods typically involve direct transfers of cash, property, or other assets. While such contributions may be associated with financial or tax considerations, existing systems provide limited capabilities for modeling, structuring, and administering long-term pledge-based funding arrangements involving financial instruments such as life insurance policies, annuities, or other assets that may produce future benefits.

Permanent life insurance policies and similar financial instruments may include death benefits, cash value components, or other financial attributes capable of being designated, allocated, or pledged for charitable purposes. However, existing financial planning and donor-management systems generally do not provide integrated tools capable of modeling the financial impact of such pledge structures, estimating value metrics associated with future benefits, or coordinating administration across donors, trusts, charitable organizations, and service providers.

In many cases, donors and charitable organizations lack access to systems capable of evaluating how various pledge configurations, policy attributes, or funding strategies may affect projected charitable support over time. Existing nonprofit donor-management systems typically track only direct contributions or simple pledges and do not integrate with insurance policies, trust structures, or valuation engines capable of estimating present-value metrics, projected funding outcomes, or comparative financial scenarios associated with long-term pledge arrangements.

Furthermore, there is a lack of unified computing platforms configured to model and optimize structured charitable pledge arrangements involving financial instruments based on multiple parameters, such as policy characteristics, actuarial assumptions, projected time horizons, interest-rate assumptions, or other financial inputs. Existing tools generally do not provide coordinated systems for evaluating alternative pledge structures, generating comparative projections, or optimizing pledge configurations relative to financial objectives or funding goals.

Advances in computing systems, data processing, and artificial intelligence technologies provide opportunities to improve the structuring and administration of complex financial arrangements, including pledge-based charitable funding strategies linked to life insurance policies or similar financial instruments. However, current platforms typically lack integrated modules capable of recording pledge commitments, associating pledged interests with financial instruments, generating valuation outputs, tracking pledge fulfillment over time, and providing optimization outputs that assist participants in evaluating different pledge configurations.

There is also a need for systems capable of generating financial-impact models associated with pledge-based arrangements, including projections based on present-value calculations, actuarial assumptions, time-based discounting parameters, or other financial metrics. Such systems may also benefit from analytics engines capable of generating comparative outputs reflecting projected funding outcomes, potential financial effects of pledge structures, or alternative configurations of policy-based charitable funding arrangements.

Additionally, there is a need for platforms capable of coordinating administration of such arrangements across multiple parties, including donors, charitable organizations, trustees, financial professionals, administrators, and other participants. Existing systems do not provide integrated environments capable of managing pledge data, policy-related data, trust information, valuation outputs, and communications across multiple stakeholders within a unified framework.

In some scenarios, financial instruments associated with charitable pledge arrangements may include policy cash values, death benefits, or other value metrics that could be used as reference points for modeling potential funding scenarios or structuring financing arrangements associated with charitable programs. However, existing systems do not provide coordinated tools for modeling, tracking, or administering such arrangements within a unified computing environment.

Accordingly, a need exists for improved systems and methods for administering and modeling charitable pledge and funding arrangements using life insurance policies, trust structures, and digital processing platforms. Such systems would benefit from integrated modules capable of recording pledge commitments, associating pledged interests with financial instruments, generating valuation and projection outputs, modeling potential financial outcomes, tracking pledge status over time, and supporting coordinated administration across multiple participants.

### SUMMARY OF THE INVENTION

The present invention provides systems and methods for structuring, optimizing, and administering charitable pledge and funding arrangements using life insurance policies, trust structures, and computer-implemented platforms. In particular, the invention provides a structured mechanism for recording donor pledges associated with life insurance policies, assigning or allocating ownership or beneficial rights in such policies to charitable entities or trusts, and determining values associated with pledged policy benefits based on financial and policy-related inputs.

In one embodiment, a computing platform is configured to record donor pledges, associate such pledges with life insurance policies or other financial instruments, and administer trust-based charitable arrangements. The computing platform may include one or more modules configured to calculate present values or other value metrics associated with pledged policy benefits using actuarial data, financial parameters, interest-rate assumptions, or other valuation inputs. Processing components may further be configured to coordinate administration of pledges, policies, trusts, and related charitable funding arrangements across multiple participants.

In certain embodiments, a life insurance policy may include a rider, allocation structure, or designation mechanism configured to assign or designate a portion of a death benefit, cash value, or other policy benefit to a charitable entity or trust while allowing other ownership or beneficial interests in the policy to be retained by a donor or related party. Ownership or beneficial rights in a policy may be divided among one or more parties and tracked, modeled, and administered by the computing platform.

The computing platform may include one or more data repositories configured to store donor information, policy information, pledge data, trust information, and charitable organization information. The platform may further include user interfaces configured for access by donors, charitable organizations, trustees, administrators, or other participants. In some embodiments, the platform may integrate with financial, insurance, tax, accounting, actuarial, or planning software systems and may generate reports, projections, or valuation outputs associated with charitable pledges or policy-based funding arrangements.

In some embodiments, the platform includes one or more optimization modules configured to generate recommendations, projections, and comparative outputs associated with charitable pledge structures, funding strategies, policy parameters, or charitable campaign goals based on stored data, actuarial inputs, financial assumptions, or modeled outcomes. Such optimization modules may analyze multiple pledge configurations, policy attributes, and funding scenarios to assist participants in identifying preferred arrangements relative to financial objectives, charitable goals, or administrative constraints.

In certain embodiments, the invention further includes modules configured to facilitate, administer, and coordinate funding or financing arrangements for charitable or nonprofit entities based on value metrics associated with life insurance policies linked to a trust or pledge arrangement. The platform may be configured to track pledge status, enforce or monitor pledge commitments, manage fulfillment events over time, and support pooled, multi-donor, or campaign-based charitable funding arrangements through integrated trust administration, reporting, and participant coordination functions.

### BRIEF DESCRIPTION OF THE DRAWINGS

FIG. 1 illustrates an overall system architecture for administering charitable pledge and funding arrangements using life insurance policies, trust structures, and a computing platform.

FIG. 2 illustrates a modular computing platform architecture including pledge management, valuation, trust administration, analytics, and communications modules.

FIG. 3 illustrates a data flow diagram showing interactions among donor inputs, policy data, trust structures, valuation engines, and nonprofit entities.

FIG. 4 illustrates a policy benefit bifurcation structure in which a life insurance policy benefit is divided between a pledged charitable portion and a retained donor portion.

FIG. 5 illustrates a trust ownership configuration in which a donor transfers ownership or beneficial rights in a life insurance policy to a trust for charitable purposes.

FIG. 6 illustrates a multi-party relationship model including donor, trustee, insurer, nonprofit organization, and computing platform.

FIG. 7 illustrates a present-value calculation engine configured to determine value metrics associated with pledged policy benefits.

FIG. 8 illustrates a deduction optimization engine configured to model tax-impact scenarios associated with charitable pledges.

FIG. 9 illustrates an AI-assisted optimization workflow configured to generate recommended pledge structures and policy parameters.

FIG. 10 illustrates a donor interface for entering pledge information and reviewing policy-based charitable arrangements.

FIG. 11 illustrates a nonprofit portal interface for tracking pledges and generating reports.

FIG. 12 illustrates an administrator interface for managing trust and pledge administration.

FIG. 13 illustrates a policy-backed financing structure in which value metrics associated with a pledged policy may support financing arrangements.

FIG. 14 illustrates a pooled donor funding model aggregating pledge data from multiple donors.

FIG. 15 illustrates an indexed universal life policy projection showing pledged and retained benefit portions and trust linkage.

FIG. 16 illustrates a present-day charitable value calculation based on projected policy benefits and actuarial assumptions.

FIG. 17 illustrates a premium financing structure involving a donor, lender, trust, and life insurance policy.

FIG. 18 illustrates a pledge creation workflow.

FIG. 19 illustrates a trust administration workflow.

FIG. 20 illustrates a reporting and compliance workflow associated with pledge administration.

### DETAILED DESCRIPTION OF THE DRAWINGS

The following detailed description is provided with reference to the accompanying drawings, which form a part of this disclosure. The drawings illustrate exemplary embodiments of systems, methods, and computing architectures for administering charitable pledge, funding, valuation, and compliance arrangements using life insurance policies, trust structures, and a computing platform. It is to be understood that the illustrated embodiments are exemplary only, and that variations, modifications, and alternative implementations may be employed without departing from the scope of the invention.

In various embodiments, the modules, engines, and components described herein may be implemented as software instructions executed by one or more processors, firmware, hardware logic, or combinations thereof. References to optimization engines, recommendation engines, or similar analytical components are intended to describe assistive computational analysis based on defined parameters and data inputs, and do not imply autonomous decision-making or independent control over charitable pledge execution.

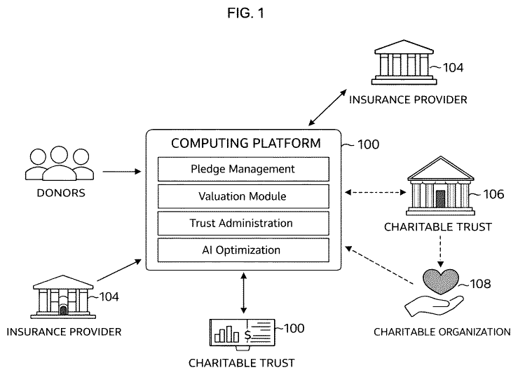

FIG. 1 illustrates an overall system architecture for administering charitable pledge and funding arrangements using life insurance policies, trust structures, and a computing platform. In various embodiments, a donor interacts with a computing platform configured to receive policy information, pledge designations, beneficiary allocations, and trust-related parameters. The platform may interface with one or more insurance carriers, trustees, nonprofit organizations, financial institutions, and regulatory systems. The architecture supports administration of pledged and retained policy benefits, valuation analysis, reporting, and post-mortem execution of charitable arrangements.

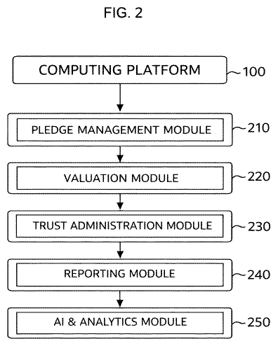

FIG. 2 illustrates a modular computing platform architecture including pledge management, valuation, trust administration, analytics, and communications modules. In some embodiments, the platform is implemented as a cloud-based system, while in other embodiments it may be implemented as a distributed or hybrid computing environment. Each module may operate independently or in coordination with other modules to support scalable administration of charitable life-insurance-based pledges across multiple donors, policies, and beneficiary entities.

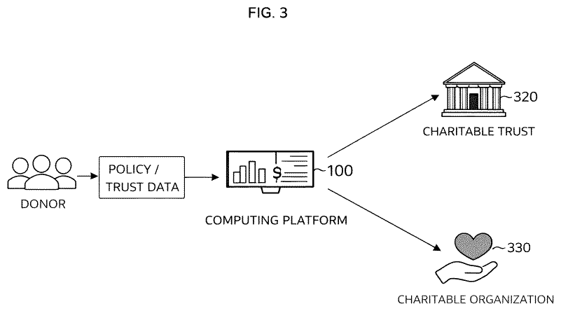

FIG. 3 illustrates a data flow diagram showing interactions among donor inputs, policy data, trust structures, valuation engines, and nonprofit entities. In various implementations, donor-provided inputs are processed alongside insurance policy data to generate valuation metrics, pledge allocations, and compliance records. Data flows may include bidirectional communications between the computing platform and external entities such as insurers, trustees, and nonprofit organizations, enabling ongoing administration, monitoring, and reporting.

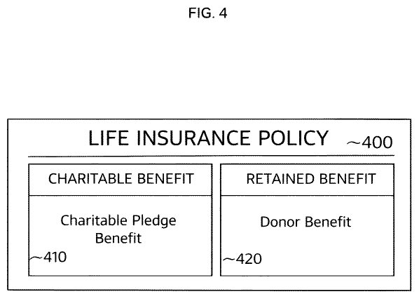

FIG. 4 illustrates a policy benefit bifurcation structure in which a life insurance policy benefit is divided between a pledged charitable portion and a retained donor portion. In some embodiments, the bifurcation is defined as a fixed percentage, while in other embodiments it may be dynamically determined based on valuation models, actuarial assumptions, or donor preferences. The bifurcated structure enables simultaneous personal and charitable objectives to be achieved within a single policy framework.

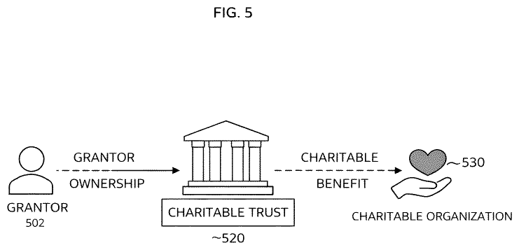

FIG. 5 illustrates a trust ownership configuration in which a donor transfers ownership or beneficial rights in a life insurance policy to a trust for charitable purposes. In various embodiments, the trust may be a charitable trust, a donor-advised trust, or a hybrid trust structure. The computing platform may track ownership status, beneficiary designations, and trust compliance requirements throughout the life of the policy.

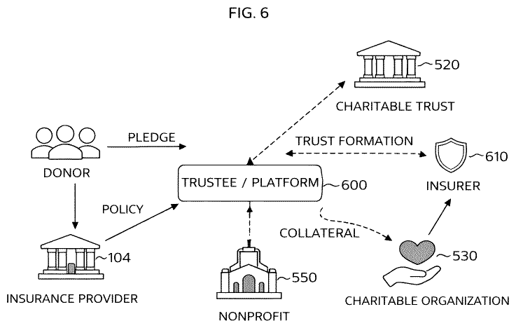

FIG. 6 illustrates a multi-party relationship model including a donor, trustee, insurer, nonprofit organization, and computing platform. The model reflects the coordinated roles and responsibilities among participating entities. In some embodiments, the computing platform acts as an administrative and informational intermediary, facilitating transparency, recordkeeping, and compliance among the parties.

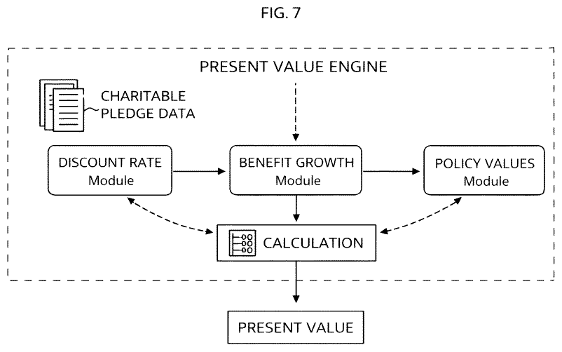

FIG. 7 illustrates a present-value calculation engine configured to determine value metrics associated with pledged policy benefits. The engine may apply actuarial assumptions, discount rates, mortality projections, and policy performance data to calculate present-day charitable value. These calculations may be used for donor decision-making, reporting, tax modeling, or financing analysis.

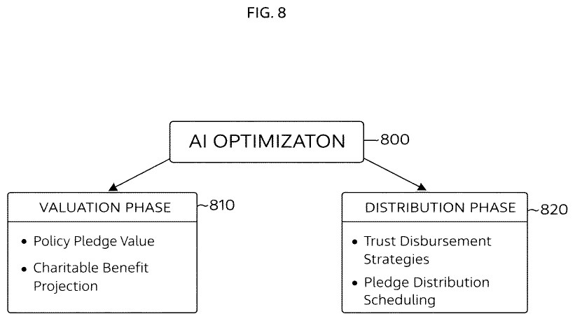

FIG. 8 illustrates a deduction optimization engine configured to model tax-impact scenarios associated with charitable pledges. In various embodiments, the engine evaluates potential tax outcomes based on jurisdictional rules, donor profiles, trust structures, and policy characteristics. The engine may generate comparative scenarios to assist donors and advisors in selecting optimal pledge configurations.

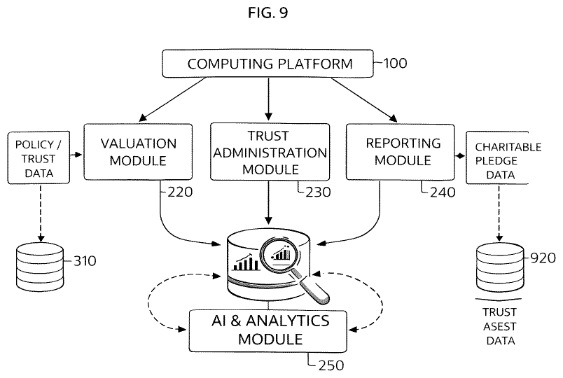

FIG. 9 illustrates an AI-assisted optimization workflow configured to generate recommended pledge structures and policy parameters. In some embodiments, artificial intelligence or machine-learning techniques analyze historical data, donor preferences, policy performance, and regulatory constraints to suggest optimized arrangements. The workflow may continuously adapt recommendations based on updated data inputs.

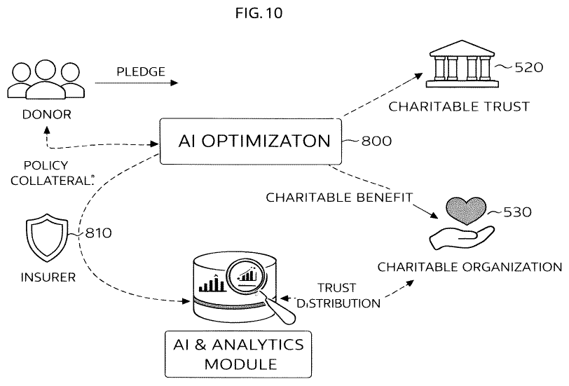

FIG. 10 illustrates a donor interface for entering pledge information and reviewing policy-based charitable arrangements. The interface may include interactive tools for configuring pledge percentages, selecting nonprofit beneficiaries, reviewing valuation outputs, and generating documentation. The interface may be accessible via web, mobile, or other computing devices.

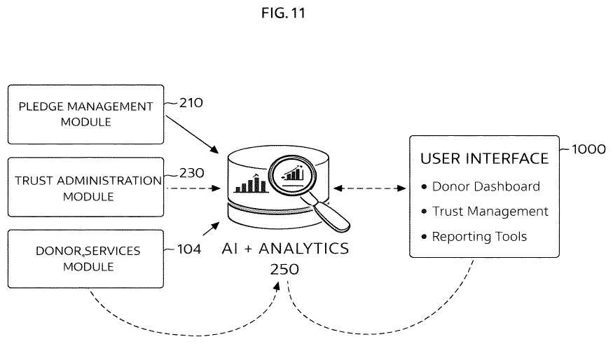

FIG. 11 illustrates a nonprofit portal interface for tracking pledges and generating reports. In various embodiments, nonprofit organizations may access pledge information, projected funding timelines, and compliance documentation through the portal. The interface may support reporting, acknowledgments, and audit preparation.

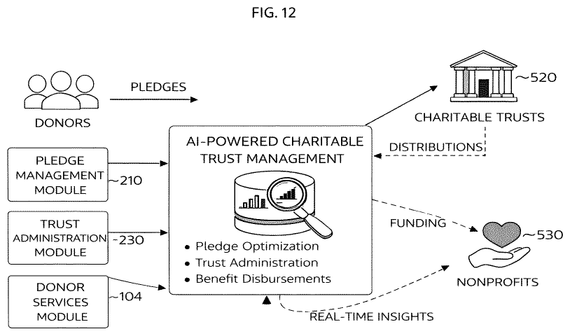

FIG. 12 illustrates an administrator interface for managing trust and pledge administration. The administrator interface may be used by platform operators, trustees, or authorized personnel to oversee donor accounts, policy status, compliance workflows, and system configuration.

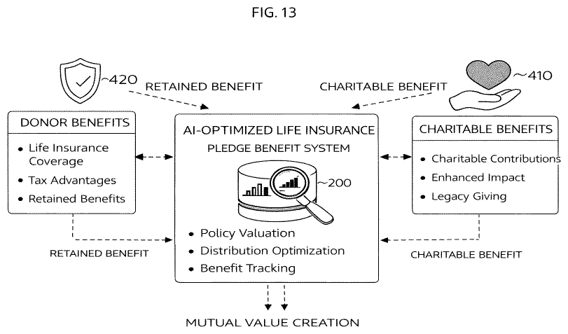

FIG. 13 illustrates a policy-backed financing structure in which value metrics associated with a pledged policy may support financing arrangements. In some embodiments, lenders evaluate pledged policy values as part of underwriting decisions, enabling financing solutions that leverage charitable pledge structures.

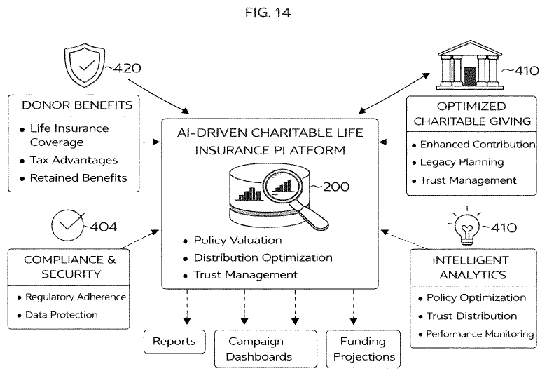

FIG. 14 illustrates a pooled donor funding model aggregating pledge data from multiple donors. The computing platform may aggregate pledged values to model collective charitable impact, funding stability, or pooled financing opportunities. Such aggregation may be applied across donor groups, organizations, or programs.

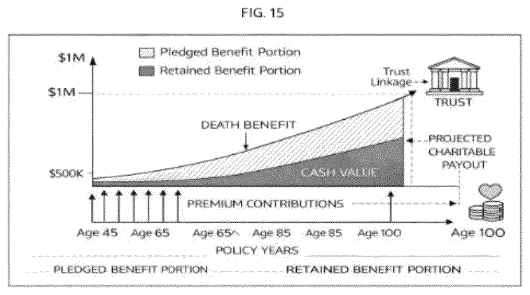

FIG. 15 illustrates an indexed universal life policy projection showing pledged and retained benefit portions and trust linkage. The projection may display policy performance scenarios over time, illustrating how pledged and retained benefits evolve under varying assumptions.

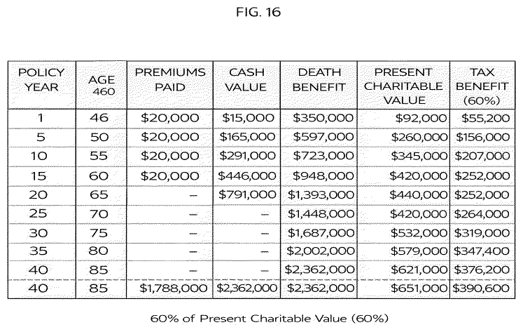

FIG. 16 illustrates a present-day charitable value calculation based on projected policy benefits and actuarial assumptions. The calculation may be updated dynamically as policy performance data or assumptions change, providing ongoing insight into charitable impact.

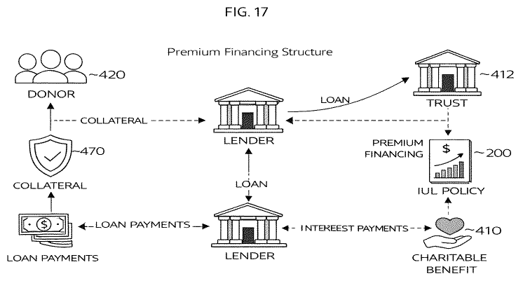

FIG. 17 illustrates a premium financing structure involving a donor, lender, trust, and life insurance policy. In various embodiments, premium financing arrangements may be coordinated through the computing platform, with tracking of obligations, collateralization, and repayment conditions.

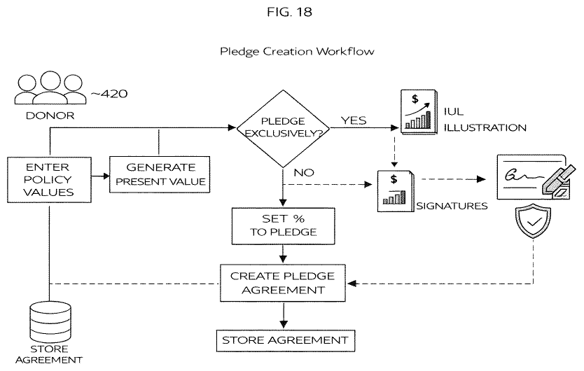

FIG. 18 illustrates a pledge creation workflow. The workflow may include donor onboarding, policy data ingestion, pledge configuration, valuation analysis, and execution of legal or administrative records.

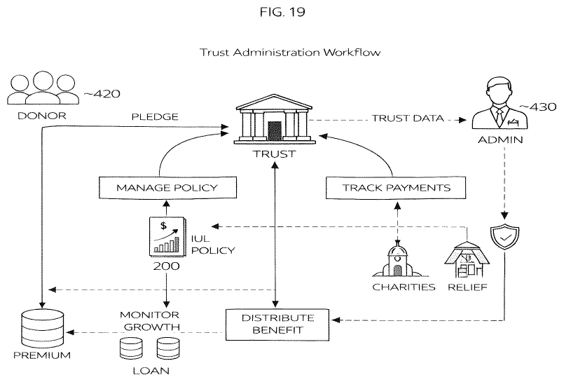

FIG. 19 illustrates a trust administration workflow. The workflow may include trust formation, policy ownership management, beneficiary tracking, compliance monitoring, and post-mortem execution procedures.

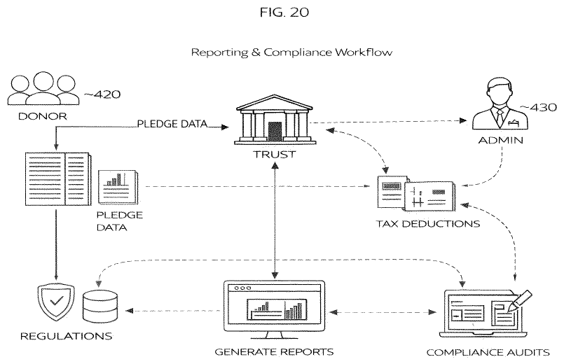

FIG. 20 illustrates a reporting and compliance workflow associated with pledge administration. The workflow may support regulatory reporting, audit preparation, donor and nonprofit disclosures, and long-term record retention.

### DESCRIPTION OF RELATED ART

Various systems have been developed relating to life insurance administration, financial planning, and charitable giving. Certain existing approaches utilize life insurance policies in connection with trusts or charitable organizations. Other systems provide illustration software, policy management tools, or financial planning platforms.

While such systems may address individual aspects of life insurance administration or charitable giving, they generally do not provide integrated platforms for administering charitable pledges associated with life insurance policies through coordinated trust structures and computing systems. In many existing arrangements, administrative functions are performed manually or through disconnected systems, which may limit coordination among donors, charitable organizations, and administrators.

Existing financial and insurance software platforms may provide calculation tools, projections, or reporting features, but often lack integrated mechanisms for associating charitable pledges with life insurance policies, allocating policy interests among multiple parties, administering trust-based charitable arrangements, and tracking pledge fulfillment over time through a unified computing platform.

Accordingly, there remains a need for improved systems and methods for administering charitable contribution arrangements associated with life insurance policies, trust structures, and computing platforms configured to manage such arrangements.

### DETAILED DESCRIPTION OF THE INVENTION

The present invention provides systems and methods for administering charitable contribution arrangements using life insurance policies, trust structures, and computing platforms configured to manage such arrangements.

In various embodiments, the invention provides a platform configured to record donor pledges associated with life insurance policies and to coordinate administration of such pledges through trust-based arrangements. The computer-implemented system may include a computing platform having one or more processors, data storage components, and network interfaces configured to manage pledge information, policy information, and participant data.

### Life Insurance Policy Structure

In certain embodiments, a life insurance policy may include a rider or allocation mechanism configured to assign a portion of a death benefit or policy value for charitable purposes. The rider may allow allocation of ownership, beneficial interests, or proceeds among multiple parties, including a donor entity and a charitable trust.

The allocated portion of the policy may be structured differently from other portions of the policy, including differences in cost, risk classification, or administrative handling. In some embodiments, commissions or compensation associated with portions of the policy may be adjusted or waived.

### Trust Structure

In certain embodiments, a trust may be established to hold or administer rights in the life insurance policy. The trust may be configured to receive assigned interests in a policy, manage administration of pledged benefits, and coordinate distribution of benefits upon occurrence of specified events. Ownership or beneficial rights in the policy may be divided between one or more entities, including donors, trusts, or charitable organizations.

### Computing Platform

The system may include a computing platform configured to:
record donor pledges
associate pledges with life insurance policies
administer trust-based arrangements
store donor and policy information
calculate values associated with pledged benefits
generate reports and projections

The computing platform may include:
databases storing donor and policy information
user interfaces for donors, administrators, or charitable organizations
secure communication modules
web-based portals
mobile applications
cloud-based storage

Multiple participants may access the platform through networked interfaces.

### Valuation and Calculation

In certain embodiments, the system may include a valuation module configured to determine values associated with pledged policy benefits. The valuation module may utilize actuarial data, discount rates, interest rate assumptions, or other financial parameters to determine present values or projected values associated with pledged benefits.

In some embodiments, valuation outputs may be generated using one or more actuarial tables, mortality projections, discounting methodologies, or regulatory reference data maintained by governmental or industry bodies, and may be updated dynamically over time.

In some embodiments, the platform may generate illustrative scenarios, comparative projections, or example outputs for educational or planning purposes without representing guaranteed outcomes.

The platform may generate charts, projections, or reports illustrating values associated with pledged benefits. These outputs may be used for planning, reporting, or administrative purposes.

### Software Integration

In certain embodiments, the computing platform may integrate with external systems, including:
insurance administration software
financial planning software
accounting software
tax preparation software
actuarial calculation systems

Such integration may allow data exchange, reporting, and coordination of pledge-related information.

### Optimization and Analytics

The system may include optimization or analytics modules configured to generate recommendations regarding pledge structures, funding strategies, or allocation of policy benefits. Such modules may utilize rule-based or algorithmic processing to evaluate alternative configurations.

### Collateralization and Funding

In certain embodiments, the system may include a collateralization module configured to enable a nonprofit or charitable entity to obtain funding secured by a cash value or other value associated with a life insurance policy. The module may facilitate access to liquidity, financing arrangements, or other funding mechanisms based on policy values.

### Multi-Participant and Pooled Arrangements

In certain embodiments, multiple donors may participate in pooled charitable arrangements administered through the computing platform. The system may track individual pledges, aggregate values, and distributions associated with pooled structures.

### Networked Access and Portals

The system may include secure portals configured to allow access by donors, charitable organizations, administrators, and other participants. The portals may provide dashboards, reporting tools, communication features, and data management functionality.

### Example Calculations

In certain embodiments, the system may calculate present values associated with pledged benefits using actuarial tables, discount rates, or other financial parameters. Such calculations may be used to generate projections or reports associated with pledged benefits. The specific calculation methods may vary depending on implementation.

### Alternative Embodiments

The invention may be implemented in various forms, including software platforms, distributed systems, or network-based environments. Components described herein may be combined, separated, or modified without departing from the scope of the invention.

What is claimed is:

1. A system for administering charitable contribution arrangements using life insurance policies or policy-linked financial benefit instruments, comprising:
a computing platform including at least one processor and memory;
a pledge management module configured to record a donor pledge associated with a life insurance policy benefit;
a trust administration module configured to administer a trust holding, owning or controlling ownership rights or beneficial rights in the life insurance policy;
a valuation module configured to determine a value associated with the donor pledge based on characteristics of the life insurance policy; and
a processing module configured to coordinate administration of the donor pledge, the trust, and the life insurance policy to facilitate charitable funding.

2. A method for administering charitable contributions using life insurance policies, comprising:
receiving, by a computing platform, a pledge from a donor;
associating the pledge with a life insurance policy;
placing, assigning or designating ownership rights, beneficial rights, or beneficiary designations associated with the policy within a trust structure;
calculating, by the computing platform, a value associated with the pledge based on policy parameters; and
administering the pledge through the computing platform.

3. A computing platform configured to administer charitable pledge programs associated with life insurance policies, comprising:
a server;
a database storing donor information, policy information, trust information, and charitable organization information;
a user interface configured to receive pledge data; and
a processing module configured to manage trust-based charitable contributions associated with life insurance policies.

4. The system of claim 1, wherein the trust administration module is configured to administer an arrangement in which a charitable organization is designated as a beneficiary of a pledged portion of a policy benefit.

5. The system of claim 1, wherein the valuation module is configured to generate present-value outputs based on actuarial data, mortality data, discount rate parameters, or financial modeling inputs.

6. The system of claim 5, wherein the discount rate parameter includes an Applicable Federal Rate (AFR) value or a user-selected rate used for estimation and reporting.

7. The system of claim 1, further comprising a compliance rules module configured to generate prompts, checklists, or documentation templates associated with charitable contribution substantiation and trust administration.

8. The system of claim 1, further comprising a nonprofit portal interface configured to enable a nonprofit organization to (i) track pledges, (ii) display campaign status, and (iii) generate donor acknowledgments or reports.

9. The system of claim 1, further comprising an integration module configured to exchange data with one or more tax, accounting, insurance illustration, actuarial, or financial planning software systems.

10. The system of claim 1, further comprising an analytics module configured to recommend pledge structures or policy parameters based on donor attributes, nonprofit campaign parameters, or fundraising goals.

11. The system of claim 10, wherein the analytics module includes an AI model configured to generate suggested pledge amounts, schedules, or donor messaging based on stored donor data and campaign data.

12. The system of claim 1, further comprising a communications module configured to deliver notifications to one or more of a donor, trustee, agent, administrator, or nonprofit representative via one or more communication channels.

13. The system of claim 1, wherein the pledge management module is configured to track pledge status over time, including pledge modifications, cancellations, policy changes, beneficiary changes, or trust changes.

14. The system of claim 1, further comprising a collateralization module configured to facilitate a financing arrangement for a nonprofit entity secured by a value metric associated with a life insurance policy or pledged policy benefit linked to the trust.

15. The system of claim 14, wherein the collateralization module is configured to generate lender-facing reports including policy cash value metrics, pledged benefit metrics, trust metadata, and authorization records.

16. The system of claim 1, wherein the pledge data includes a pledged percentage of a policy benefit up to a configurable maximum percentage, including up to one hundred percent.

17. The system of claim 1, wherein the system is configured to support pooled charitable funding in which pledge data from a plurality of donors is aggregated for reporting or financing purposes.

18. The system of claim 1, further comprising a policy configuration interface configured to record a bifurcation of a policy benefit into (i) a pledged portion and (ii) a non-pledged portion for tracking and reporting.

19. The system of claim 18, wherein the policy configuration interface is configured to output separate illustrations, columns, or reports distinguishing the pledged portion from the non-pledged portion.

20. The system of claim 1, wherein the trust administration module is configured to store, generate, or modify trust templates and to maintain an audit log of trust actions, pledge actions, and policy-related actions.
